(19) United States
(12) Patent Application Publication
(10) Pub. No.: US 2006/0205063 A1
(43) Pub. Date: Sep. 14, 2006

(54) Floor system for composting

(76) Inventor: Ronald K. Warren, Canton, NC (US)

Correspondence Address: FRASER MARTIN & MILLER LLC, 28366 KENSINGTON LANE, PERRYSBURG, OH, 43551, US

(21) Appl. No.: 11/079,612

(22) Filed: Mar. 14, 2005

(51) Int. Cl. C05F 17/02

(52) U.S. Cl. 435/290.1; 435/283.1

(57) ABSTRACT

A composting floor system is disclosed for accelerated and uniform decomposition of organic matter, the composting floor system including a gas delivery system, wherein the floor system facilitates drainage and collection of leachate generated during the composting process, and a collection of leachate and an efficiency and speed of aerobic composting are maximized.

### FIELD OF THE INVENTION

The present invention relates to a floor system for composting, and more particularly to a composting floor system that facilitates a forced aeration of the organic material within the compost pile and a capture of leachate generated during the process.

### BACKGROUND OF THE INVENTION

Composting is a biological process which transforms organic materials into a stable, easily handled, and potentially valuable product called compost. Compost bins are commonly employed to contain a mixture of organic matter, such as vegetable refuse, municipal solid waste, sludge, manure, animal mortalities, and the like, for converting the same into useful compost for fertilizing and conditioning soil. The composting process requires a carbon source such as sawdust, a nitrogen source such as the organic matter listed above, moisture, and oxygen. A common approach to composting includes mixing and stacking the carbon source and the nitrogen source in a compost bin and introducing air to the mixture of organic materials through various means.

The composting process consumes large amounts of oxygen. Thus, an air or gas delivery means is typically used to introduce air or gas to the organic material. The delivery means commonly consists of compressed air supplied through perforated pipes or plates disposed on the base of the compost bin or pile. The pipes or plates are often damaged by associated equipment such as front-end loaders used during the unloading of compost from the bin.

The air delivery means used in prior art structures often results in insufficient amounts of oxygen being supplied to certain areas of the compost bin. Without sufficient oxygen, these areas within the composting bin tend to process at a slower rate than the rest of the material, and undesirable odors may emanate from the composting mixture.

In order to optimize the composting process, the moisture content of the mixed ingredients should be between 40 percent and 60 percent. Given these higher levels of moisture, and the natural inconsistency of the materials being composted, leachate will be generated. The floor systems used in prior art structures often require that parts of the floor be removed to clean out the leachate that accumulates during the composting process since leachate is allowed to drain through holes in the floor and collect underneath the floor. Thus, it becomes difficult to capture the leachate for disposal or reuse in the composting process.

Another method of reducing the leachate generated is to compensate for excess moisture by reducing the overall moisture content to a level where little or no leachate is generated. However, this practice significantly reduces the efficiency of the composting process, and increases the amount of time required to complete the composting process.

It would be desirable to produce a floor system for composting having a gas delivery system, wherein the flooring system facilitates drainage and collection of leachate generated during the composting process, and a collection of leachate and an efficiency and speed of aerobic composting are maximized.

### SUMMARY OF THE INVENTION

Consistent and consonant with the present invention, a floor system for composting having a gas delivery system, wherein the flooring system facilitates drainage and collection of leachate generated during the composting process, and a collection of leachate and an efficiency and speed of aerobic composting are maximized, has surprisingly been discovered.

In one embodiment, the floor system for composting comprises a base portion having a plurality of trenches formed therein; a plurality of gas distribution conduits, each of the gas distribution conduits disposed in one of the trenches of the base portion and having a plurality of apertures formed therein, the plurality of gas distribution conduits adapted to be in fluid communication with a source of pressurized gas; and a header portion having a trench formed therein cooperating with the trenches of the base portion to facilitate drainage of leachate from the compost system, the header portion abutting an end of the base portion.

In another embodiment, the floor system for composting comprises a base portion having a plurality of trenches formed therein; a plurality of gas distribution conduits, each of the gas distribution conduits disposed in one of the trenches of the base portion and having a plurality of apertures formed therein, the plurality of gas distribution conduits adapted to be in fluid communication with a source of pressurized gas; a header portion having a trench formed therein cooperating with the trenches of the base portion to facilitate drainage of leachate from the compost system, the header portion abutting an end of the base portion; and a leachate collection conduit disposed in the trench of the header portion and adapted to be in fluid communication with one of a leachate storage system and a leachate treatment system, the leachate collection conduit having a plurality of apertures formed therein to facilitate a collection of the leachate in the leachate collection conduit to drain the leachate to the one of the leachate storage system and the leachate treatment system.

In another embodiment, the floor system for composting comprises a base portion including a plurality of block portions, each of the block portions having a trench formed therein; a plurality of gas distribution conduits, each of the gas distribution conduits disposed in one of the trenches of the block portions and having a plurality of apertures formed therein; a header portion having a trench formed therein cooperating with the trenches of the base portion to facilitate drainage of leachate from the compost system, the header portion abutting an end of the base portion; a gas supply header disposed in the trench of the header portion and providing communication between a source of pressurized gas and the gas distribution conduits; and a leachate collection conduit disposed in the trench of the header portion and adapted to be in fluid communication with one of a leachate storage system and a leachate treatment system, the leachate collection conduit having a plurality of apertures formed therein to facilitate a collection of the leachate in the leachate collection conduit to drain the leachate to the one of the leachate storage system and the leachate treatment system.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a partial perspective view of a composting floor system according to an embodiment of the invention;

FIG. 2 is a sectional view of the composting floor illustrated in FIG. 1 taken along line 2-2;

FIG. 3 is an end view of a gas supply header and a leachate collection conduit illustrated in FIG. 1;

FIG. 4 is an enlarged plan view of a gas supply conduit illustrated in FIG. 1 and showing apertures formed in the conduit;

FIG. 5 is a sectional view of the gas supply conduit illustrated in FIG. 4 taken along line 5-5;

FIG. 6 is a sectional view of the leachate collection conduit illustrated in FIGS. 1 and 3;

FIG. 7 is a partial perspective view of a composting floor system according to another embodiment of the invention;

FIG. 8 is an end view of a composting floor block portion showing an end of the block opposite the end abutting a header portion; and

FIG. 9 is an end view of a header portion showing the gas supply header and the leachate collection conduit illustrated in FIG. 7.

### DETAILED DESCRIPTION OF THE PREFERRED EMBODIMENT

The following detailed description and appended drawings describe and illustrate various exemplary embodiments of the invention. The description and drawings serve to enable one skilled in the art to make and use the invention, and are not intended to limit the scope of the invention in any manner.

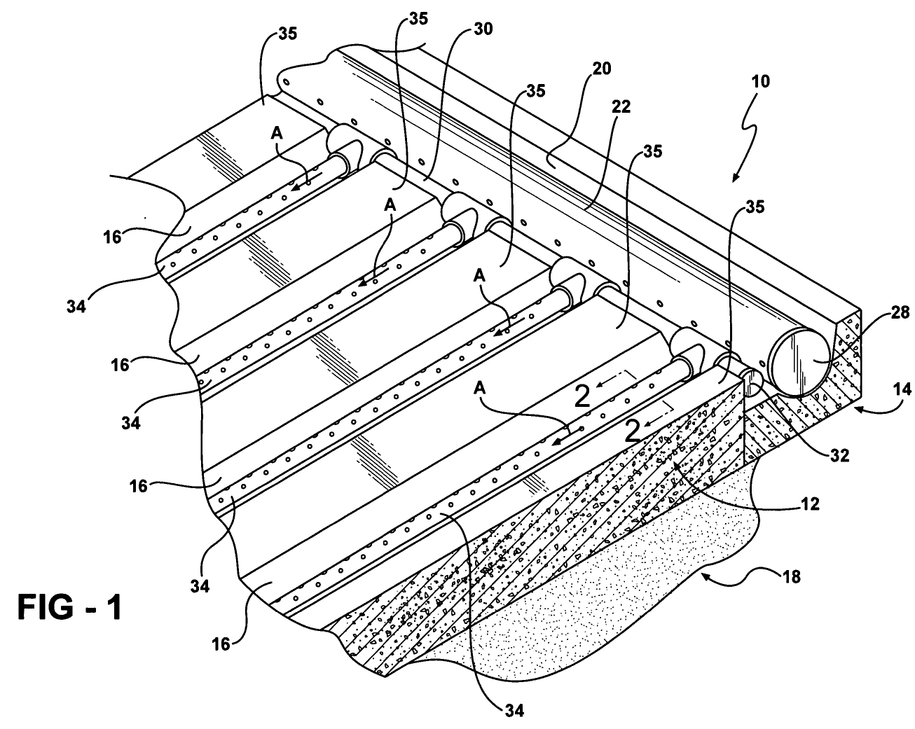

FIG. 1 illustrates a floor system 10 for composting according to an embodiment of the invention. A compost bin or pile (not shown) is disposed on the floor system 10. A length and width of the floor system 10 can be adjusted to match that of the compost bin or pile. Walls (not shown) can also extend upwardly from a periphery of the floor system 10.

The floor system 10 includes a base portion 12 and a header portion 14. A plurality of spaced apart, substantially parallel trenches 16 are formed in the base portion 12. Any desired cross sectional shape can be used for the trenches 16 such as a V-shape, a rectangular shape, or a rounded or semicircular shape, for example. The base portion 12 is sloped towards the header portion 14. It is understood that a substructure 18 of the base portion 12 can be sloped to result in the desired slope of the base portion 12.

The header portion 14 is disposed at an end of the base portion 12. The slope of the base portion 12 is towards the header portion 14. A trench 20 is formed in the header portion 14 to be substantially perpendicular to the trenches 16 of the base portion 12. The trenches 16 of the base portion 12 are in fluid communication with the trench 20 of the header portion 14. In the embodiment shown, the header portion 14 is not sloped. However, it is understood that the header portion 14 or the trench 20 of the header portion. 14 can be sloped as desired.

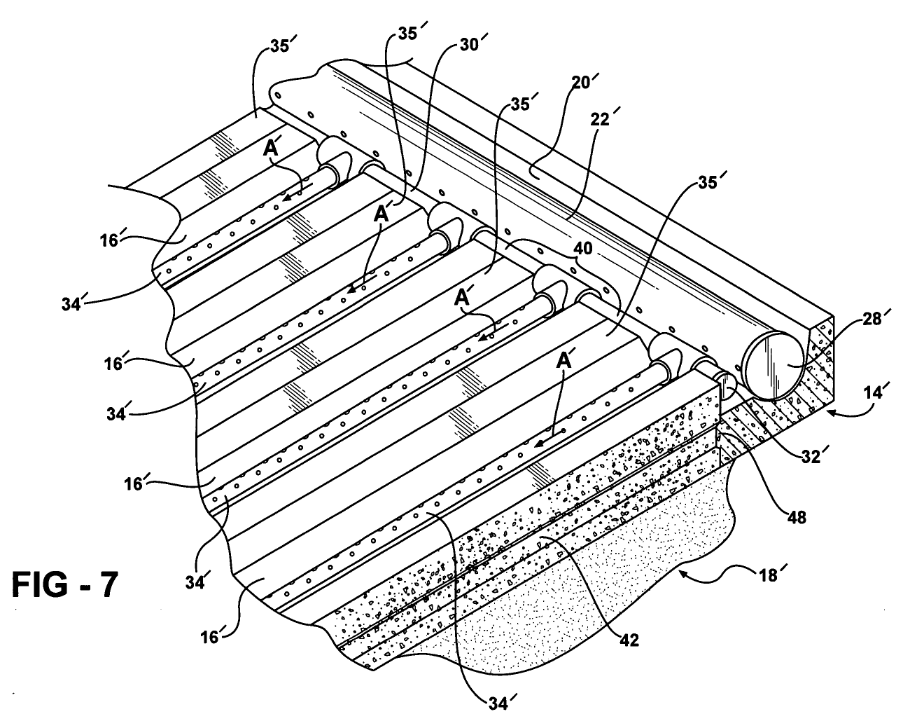

A leachate collection conduit 22 is disposed in the trench 20 of the header portion 14. The leachate collection conduit 22 is in fluid communication with a leachate storage system (not shown), a leachate treatment system (not shown) as desired, or simply permitted to drain from the floor system 10. As clearly shown in FIG. 6, the leachate collection conduit 22 includes an annular array of apertures 24 formed therein. In the embodiment shown, the apertures 24 are disposed in the bottom portion of the leachate collection conduit 22 to facilitate the collection of leachate 26. The apertures 24 permit the leachate 26 to enter the leachate collection conduit 22 and be removed from the floor system 10. A direction of flow of the leachate 26 is indicated by the arrows L. A cap 28 is disposed at an end of the leachate collection conduit 22 to militate against leachate 26 escaping. However, it is understood that both ends of the leachate collection conduit 22 can be in communication with the leachate storage or treatment system.

A gas supply header 30 is disposed adjacent the leachate collection conduit 22 in the trench 20 of the header portion 14. In the embodiment shown, air is used. However, it is understood that other gases such as a mixture of gases containing oxygen can be used. The gas supply header 30 is in communication with a source of pressurized gas (not shown) such as a pressurized tank or a fan, for example. Typically, it is desired to have the gas supply header 30 in the trench 20 at a higher point than the leachate collection conduit 22 as illustrated in FIG. 3. An end cap 32 is disposed on an end of the gas supply header 30 to militate against the escape of gas therefrom.

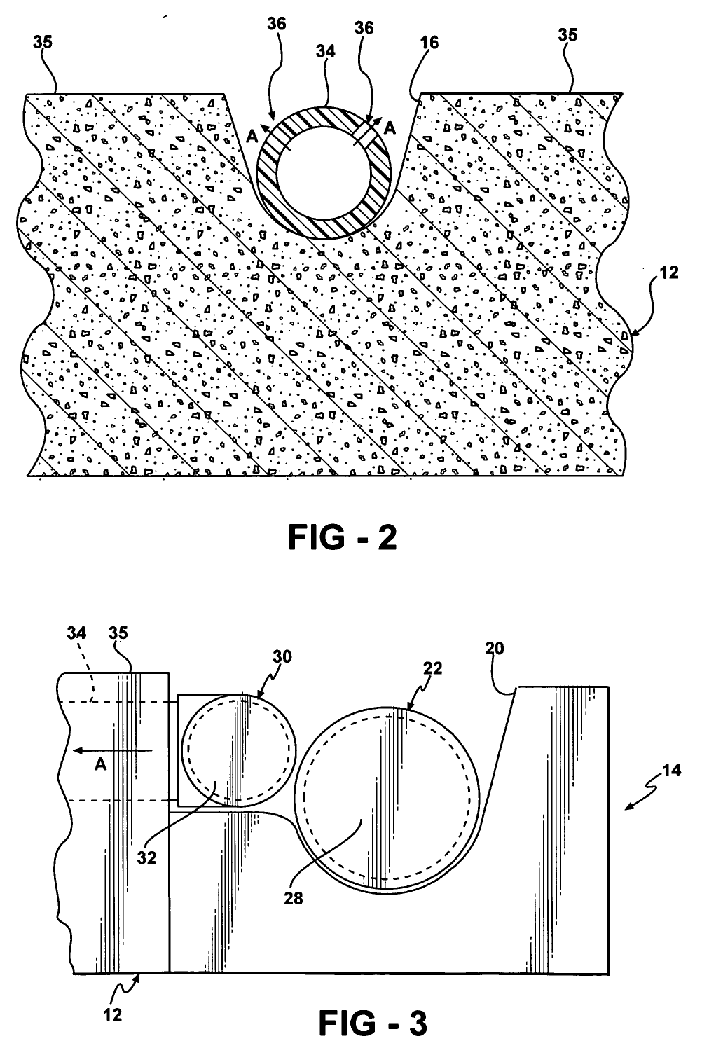

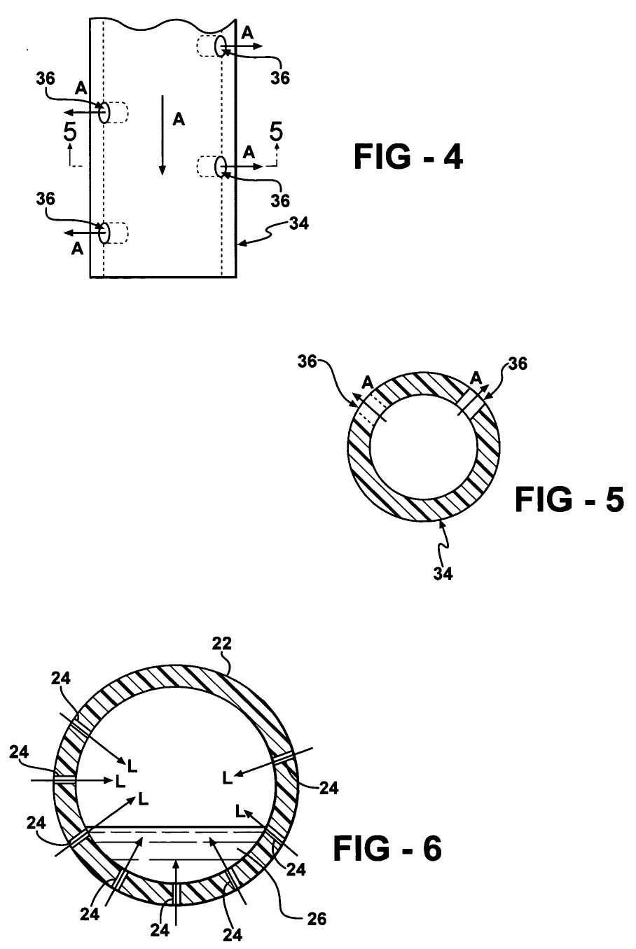

A gas distribution conduit 34 is disposed in each one of the trenches 16. The depth of the trenches 16 and the diameter of the gas distribution conduits 34 cooperate to maintain a top portion of the gas distribution conduits 34 at or below planar surface portions 35. The gas distribution conduits 34 are in fluid communication with the gas supply header 30. Flow of gas through the gas distribution conduits 34 is indicated by the arrows A. A valve (not shown) can be disposed between the gas supply header 30 and the gas distribution conduits 34 to control the flow of gas into each of the gas distribution conduits 34. Additionally, a control system (not shown) can be used to regulate flow into the gas supply header 30 and the gas distribution conduits 34 as desired. The control system may include timers and valves, for example. An annular array of spaced apart apertures 36 are formed in the gas distribution conduits 34, as clearly shown in FIGS. 2, 4, and 5. In the embodiment shown, the apertures 36 are disposed in the upper portion of the gas distribution conduit 34 to direct the flow of the gas upwardly. A diameter, quantity, and location of the apertures 36 can be varied to control the flow of the gas as desired.

In operation, organic material is disposed on the floor system 10. The gas is supplied to the organic material by the gas supply header 30 and the gas distribution conduits 34. The flow of gas is directed into the organic material by the apertures 36 formed in the gas distribution conduits 34 to facilitate the composting process. The oxygen supplied with the gas provides the needed oxygen to the aerobic microorganisms in order to begin the decomposition of the organic material. In one embodiment, the flow of gas into the organic material is accomplished by the alignment of the apertures 36 of the gas distribution conduits 34 in two rows spaced substantially ninety degrees apart as illustrated in FIG. 5. However, it is understood that other configurations of the apertures 36 can be used without departing from the scope and spirit of the invention.

During the decomposition of the organic material, any leachate 26 or excess moisture formed is directed to the header portion 14 by the base portion 12. The leachate 26 is caused to flow to the header portion 14 by the trenches 16 formed in the base portion 12, the slope of the base portion 12, or a combination of the trenches 16 and the slope. The leachate 26 is collected in the trench 20 of the header portion 14. The leachate 26 is directed towards a collection point by the trench 20. Additionally, the leachate 26 enters the leachate collection conduit 22 through the apertures 24 formed therein. Collected leachate 26 can be stored for later removal and treatment, can be directed to a treatment system (not shown), can be re-used in the composting process, or simply permitted to drain from the floor system 10.

Once the organic material has been converted to compost material, the compost material can be removed from the floor system 10. Any conventional removal method can be used such as by hand with a shovel or with a front end loader, as desired. The gas distribution conduits 34 are protected from damage during removal of the compost material since the top of the gas distribution conduits 34 are positioned at or below the planar surface portions 35.

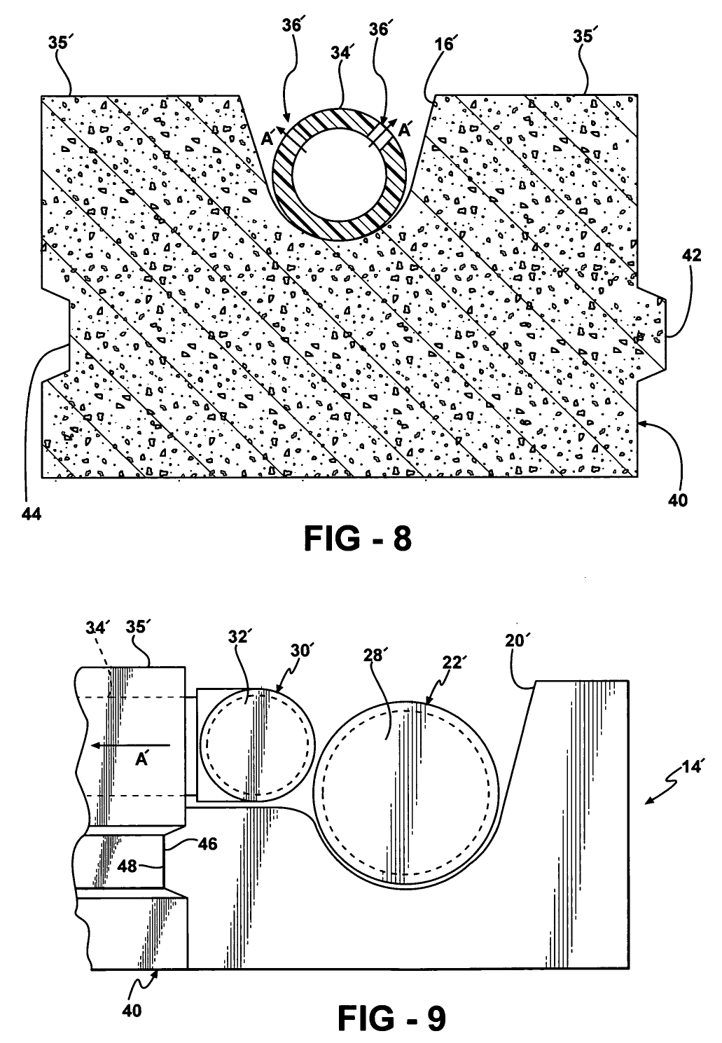

Another embodiment of the invention is illustrated in FIGS. 7, 8, and 9. Like structure from FIGS. 1-6 is shown in FIGS. 7-9 with the same reference numeral and a prime “′” symbol. In this embodiment, the base portion 12′ is produced from a plurality of elongate block portions 40 as shown in FIG. 8. Each of the block portions 40 includes a protuberance 42 such as a tongue in a tongue and groove joint, for example, formed in one side thereof. A depression 44 such as a groove in a tongue and groove joint, for example, is formed in an opposite side thereof. When individual block portions 40 are disposed adjacent and substantially parallel with one another, the protuberance 42 of one block portion 40 is received in the depression 44 of an adjacent block portion 40. Thus, a desired width of the base portion 12′ can be attained by placing block portions 40 in a side by side relation until the desired width is reached.

As shown in FIG. 9, an end of the block portions 40 abutting the header portion 14′ has a depression 46 such as a groove in a tongue and groove joint formed therein. The depression 46 formed on the end of the block portions 40 receives a protuberance 48 such as a tongue in a tongue and groove joint formed on the header portion 14′. It is understood that a depression can be formed on the header portion 14′ and a protuberance can be formed on the ends of the block portions 40 without departing from the scope and spirit of the invention. The protuberances 42, 48 and the depressions 44, 46 facilitate an alignment between adjacent block portions 40, and the block portions 40 and the header portion 14′, and militate against relative movement therebetween. Producing the floor system 10′ using the block portions 40 allows for large scale production, thus minimizing costs. The block portions 40 can be produced in a variety of lengths, thereby facilitating use in a variety of applications. The operation of the floor system 10′ is the same as previously described for the other embodiment of the invention.

The floor system 10, 10′ produced according to the various embodiments of the invention facilitates the drainage, capture, removal, treatment, or reuse of excess leachate 26, 26′ generated in the composting process. Additionally, gas supply is consistently and equally distributed throughout the organic material being composted. The floor system 10, 10′ can be economically manufactured at one or more central facilities and transported to a desired site for efficient and simple installation. The floor system 10, 10′ also readily accommodates variations in the width and length of the compost bin or pile.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A floor system for a compost system comprising:
a base portion having a plurality of trenches formed therein;
a plurality of gas distribution conduits, each of said gas distribution conduits disposed in one of the trenches of said base portion and having a plurality of apertures formed therein, said plurality of gas distribution conduits adapted to be in fluid communication with a source of pressurized gas; and
a header portion having a trench formed therein cooperating with the trenches of said base portion to facilitate drainage of leachate from the compost system.

2. The floor system according to claim 1, further comprising a gas supply header disposed in the trench of said header portion and providing communication between the source of pressurized gas and said gas distribution conduits.

3. The floor system according to claim 2, further comprising a leachate collection conduit disposed in the trench of said header portion, said leachate collection conduit having a plurality of apertures formed therein to facilitate a collection of the leachate in said leachate collection conduit to drain the leachate from the floor system.

4. The floor system according to claim 1, wherein the trenches of said base portion are substantially parallel to one another.

5. The floor system according to claim 1, wherein the apertures of each of said gas distribution conduits are arranged in two spaced apart rows.

6. The floor system according to claim 1, wherein said base portion includes a plurality of block portions.

7. The floor system according to claim 6, wherein each of the block portions include a protuberance formed on one side thereof and a depression formed on an opposite side thereof.

8. The floor system according to claim 7, wherein said header portion abuts an end of the block portions, each of the block portions including one of a protuberance and a depression formed on the end thereof to cooperate with an other of a protuberance and a depression formed on a side of said header portion abutting the block portions.

9. The floor system according to claim 3, wherein the trench of said header portion includes a first level and a second level formed therein, wherein the first level supports said gas supply header and the second level supports said leachate collection conduit.

10. A floor system for a compost system comprising:
a base portion having a plurality of trenches formed therein;
a plurality of gas distribution conduits, each of said gas distribution conduits disposed in one of the trenches of said base portion and having a plurality of apertures formed therein, said gas distribution conduits adapted to be in fluid communication with a source of pressurized gas;
a header portion having a trench formed therein cooperating with the trenches of said base portion to facilitate drainage of leachate from the compost system; and
a leachate collection conduit disposed in the trench of said header portion, said leachate collection conduit having a plurality of apertures formed therein to facilitate a collection of the leachate in said leachate collection conduit to drain the leachate from the floor system.

11. The floor system according to claim 10, further comprising a gas supply header disposed in the trench of said header portion and providing communication between the source of pressurized gas and said gas distribution conduits.

12. The floor system according to claim 10, wherein the trenches of said base portion are substantially parallel to one another.

13. The floor system according to claim 10, wherein the apertures of each of said gas distribution conduits are arranged in two spaced apart rows.

14. The floor system according to claim 10, wherein said base portion includes a plurality of block portions.

15. The floor system according to claim 14, wherein each of the block portions include a protuberance formed on one side thereof and a depression formed on an opposite side thereof.

16. The floor system according to claim 15, wherein said header portion abuts an end of the block portions, each of the block portions including one of a protuberance and a depression formed on the end thereof to cooperate with an other of a protuberance and a depression formed on a side of said header portion abutting the block portions.

17. A floor system for a compost system comprising:
a base portion including a plurality of block portions, each of the block portions having a trench formed therein;
a plurality of gas distribution conduits, each of said gas distribution conduits disposed in one of the trenches of the block portions and having a plurality of apertures formed therein;
a header portion having a trench formed therein cooperating with the trenches of the block portions of said base portion to facilitate drainage of leachate from the compost system, said header portion abutting an end of said base portion;
a gas supply header disposed in the trench of said header portion and providing communication between a source of pressurized gas and said gas distribution conduits; and
a leachate collection conduit disposed in the trench of said header portion and adapted to be in fluid communication with one of a leachate storage system and a leachate treatment system, said leachate collection conduit having a plurality of apertures formed therein to facilitate a collection of the leachate in said leachate collection conduit to drain the leachate to the one of the leachate storage system and the leachate treatment system.

18. The floor system according to claim 17, wherein each of the block portions include a protuberance formed on one side thereof and a depression formed on an opposite side thereof.

19. The floor system according to claim 17, wherein each of the block portions include one of a protuberance and a depression formed on an end thereof to cooperate with an other of a protuberance and a depression formed on a side of said header portion.

20. The floor system according to claim 17, wherein the trench of said header portion includes a first level and a second level formed therein, wherein the first level supports said gas supply header and the second level supports said leachate collection conduit.
